(19) United States
(12) Patent Application Publication
(10) Pub. No.: US 2026/0147799 A1
(43) Pub. Date: May 28, 2026

(54) USING METAHEURISTICS TO OPTIMIZE DOCUMENT RETRIEVAL IN LLMS

(71) Applicant: Dell Products L.P., Round Rock, TX (US)

(72) Inventors: Herberth Birck Fröhlich, Florianópolis (BR); Iam Palatnik de Sousa, Rio de Janeiro (BR); Marcus Vinicius Libardi Pazini, Caxias do Sul (BR); Werner Spolidoro Freund, Rio de Janeiro (BR)

(21) Appl. No.: 18/960,479

(22) Filed: Nov. 26, 2024

(51) Int. Cl. G06F 16/3329; G06F 16/332; G06F 16/334

(52) U.S. Cl. CPC G06F 16/33295; G06F 16/3326; G06F 16/334

(57) ABSTRACT

One example method optimizes information by receiving a query from a user, in response to the query, retrieving information that includes documents relevant to the query, calculating a respective information value (IV) for each of the retrieved documents, counting a token length for each of the retrieved documents, selecting, from among the retrieved documents, an optimal document set that includes a set of the retrieved documents that maximizes an amount of information, while respecting a token budget, and inserting the optimal document set into a context window so as to enhance an output of an LLM with documents of the optimal document set.

### TECHNOLOGICAL FIELD OF THE DISCLOSURE

Embodiments disclosed herein generally relate to retrieval of information, such as by or at the direction of a chatbot for example, responsive to a user query. More particularly, at least some embodiments relate to systems, hardware, software, computer-readable media, and methods, for using metaheuristics to optimize document retrieval in LLMs.

### BACKGROUND

At present, Large Language Models (LLMs) are a state-of-the-art foundation models for text generation. Although they perform amazingly well in some tasks, in other situations their output can be significantly incorrect. This inaccuracy in output generation can be attributed to two factors, namely, the model hallucinating information that does not correspond with the truth, and the fact that sometimes the LLM was simply not trained with the most up to date information about the subject it was queried to generate a response.

One way of avoiding the problem of LLMs outputting responses that are not up to date with the latest information is using retrieval methods. These methods, also known as Retrieval Augmented Generation (RAG), are generally concerned with searching within a database for the most current documents related to the context of the question issued, such as by a user, to the LLM and combining those documents with the prompt that goes into the model, that is, the LLM. This way, the model is instructed to answer the user question based on the retrieved content and does not need to rely solely on the information that was stored in its weights during training of the LLM.

Even though RAG is a useful tool to enhance LLM performance without retraining, the transformer, which is the basic architecture for LLMs, can process only a finite amount of input tokens, limiting the amount of data that the RAG can incorporate into the LLM prompt. Thus, it may become necessary to choose which documents will be selected from a vast corpus, as the documents in that corpus might differ in information and size, to maximize the amount of information given to the LLM while respecting the limit of input tokens.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example BnB (branch-and-bound) algorithm.

FIG. 2 discloses aspects of a method for identifying an optimal set of documents after document retrieval, according to one embodiment.

FIG. 3 discloses aspects of a method for attributing information values to documents, according to one embodiment.

FIG. 4 discloses a table with example values for an illustrative BnB problem.

FIG. 5 discloses a numerical example of a branching process in an illustrative BnB problem.

FIG. 6 discloses a complete example of a BnB solution approach, according to one embodiment.

FIG. 7 discloses a computing entity configured and operable to perform and/or direct the performance of any of the disclosed methods, processes, and operations.

### DETAILED DESCRIPTION OF SOME EXAMPLE EMBODIMENTS

Embodiments disclosed herein generally relate to retrieval of information, such as by or at the direction of a chatbot for example, responsive to a user query. More particularly, at least some embodiments relate to systems, hardware, software, computer-readable media, and methods, for using metaheuristics to optimize document retrieval in LLMs.

One or more embodiments comprise methods and architectures for information retrieval. An embodiment may be implemented in connection with a chatbot, or other virtual assistant, but that is not required. More generally, an embodiment may be implemented in connection with any circumstance6, systems, and methods, in which a request for information is generated, and received.

One method, which may be performed in whole or in part by an LLM, according to an embodiment may comprise operations including: receiving input, such as a query or request for information, from a user; in response to the query, retrieving relevant documents from a database; calculating a respective information value for each of the retrieved documents; counting a token length for each of the retrieved documents; selecting, from among the retrieved documents, an optimal document set that maximizes an amount of information, while respecting a token budget; and, inserting the optimal document set into a context window so as to enhance the LLM output with the gathered external documents.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may improve RAG performance. An embodiment may identify and gather optimal information responsive to a request. An embodiment may strike a balance between information value and a constraint such as a token, or input document size, budget of an LLM, when identifying an optimal set of documents. Various other advantages of one or more example embodiments will be apparent from this disclosure.

### A. REFERENCES

Reference may be made herein to one or more of the following documents, each of which is incorporated herein in its respective entirety by this reference.
[1]M. C. M. A. S. M. M. D. C. D. J. Steven Bethard, “SemEval-2017 Task 1: Semantic Textual Similarity Multilingual and Crosslingual Focused Evaluation,” Proceedings of the 11th International Workshop on Semantic Evaluation (SemEval-2017), vol. 11, pp. 1-14, 2017.
[2]S. E. Robertson, S. Walker, S. Jones and M. H.-B. &. M. Gatford, “Overview of the Third Text Retrieval Conference (TREC-3),” NIST Special Publication 500-226, Gaithersburg, USA, 1994.
[3]J. L. S. Beel, “Research-paper recommender systems: a literature survey,” International Journal on Digital Libraries, vol. 17, no. 4, pp. 305-338, 2016.
[4]K. C. G. C. J. D. Tomas Mikolov, “Efficient Estimation of Word Representations in Vector Space,” arXiv preprint arXiv:1301.3781, 2013.
[5]A. G. D. A. H. Land, “An Automatic Method of Solving Discrete Programming Problems,” Econometrica, vol. 28, no. 3, pp. 497-520, 1960.

### B. ASPECTS OF AN EXAMPLE CONTEXT FOR ONE OR MORE EMBODIMENTS

The following is a discussion of aspects of an example context for various embodiments. This discussion is not intended to limit the scope of the claims or this disclosure, or the applicability of the embodiments, in any way. In general, this section provides information concerning various concepts employed or referenced in connection with one or more embodiments. This information includes how a basic implementation of a RAG based solution works, what exactly the Knapsack Problem (KP) is, how to obtain the information value of textual content (IV), and an explanation of the Branch and Bound (BnB) algorithm used in one or more embodiments to solve the KP.

### B.1 Standard RAG Method

RAG (Retrieval-Augmented Generation) is an advanced natural language processing (NLP) technique that combines information retrieval with text generation. It addresses the limitations of large language models by integrating external knowledge sources during the generation process.

In RAG, the LLM (large language model), or simply ‘language model,’ or ‘model,’ first retrieves relevant information from a knowledge base, such as a pre-existing database or a search engine. This retrieved content is then used to augment the internal representation of the model. By incorporating external facts, that is, the retrieved information, RAG produces more context-aware and accurate responses. The retrieval process may help to ensure that the generated text is grounded in reliable information, reducing the risk of false or outdated answers in response to a user query.

Even though RAG proportionate improved precision achieved through the integration of external data, which enhances the reliability of responses, RAG fails in finding what is the best possible set of documents to be integrated in the final LLM prompt, which results in somewhat improved, but still suboptimal, performance of LLM applications.

### B.2 The Knapsack Problem (KP)

KP derives its name from the problem faced by a hypothetical individual whose task is to pack a knapsack of limited size with the highest amount of value among all available items in the non-trivial case where the number of possible items to be packed cannot surpass the capacity available in the knapsack. This seemingly naïve task is a well-studied problem in combinatorial optimization and often arises in areas such as resource allocation.

A more formal assertion for the Knapsack Problem is:
“Given a set of items, each with a weight and a value, determine which items to include in the collection so that the total weight is less than or equal to a given limit and the total value is as large as possible.”

In the case of one or more embodiments, the knapsack capacity (W) is the number of tokens of context window destined, or allocated, for the information obtained from external sources that must be passed to augment the generation capability of the LLM, that is, the information obtained by RAG from a database and/or other source.

In mathematical terms, the KP is defined as follows:

$$maximize {\sum }_{i = 1}^{N} {v}_{i} {x}_{i}$$

$$subject to {\sum }_{i = 1}^{N} {w}_{i} {x}_{i} \leq W and {x}_{i} ∈ \{ 0 , 1 \}$$

where, vᵢ represents the value of the i-th item, xᵢ can assume the value of 1 or 0, indicating if the item has been picked or not, wᵢ is the particular weight of the i-th item and W is the constraint of the problem, that is, the maximum weight that can be packed. With this formulation, techniques such as Branch and Bound (BnB) and Dynamic Programming can be applied to search for the optimal solution.

### B.3 Information Value (IV) Algorithms

For an algorithm to be utilized as a source of information value in the context of one or more embodiments, that algorithm may satisfy only one property, that is, the algorithm should be able, given a user query, to compare the user input with the available textual documents in a database and return one value of IV E R for each document. This value may be be a measurement of how relevant the information presented in a document is with respect to the user current input. Thus, the higher the returned IV is for a document, the more relevant the information in the document is to the user query.

Some example IV algorithms that can be utilized in one or more embodiments are briefly described below, and further information concerning these is available in [1].
1. Lexical Search: It is a method that primarily relies on literal or surface level representations of words and sentences in a query with an external content, such as a database for example. The idea is to look for exact matches of keywords in a string of text, without considering broader meaning or context. Although this approach can be precise in some circumstances, it can also lead to missing results in cases where keywords or exact terms are not present in the initial query. For the purposes of one or more embodiments, the IV provided by a lexical search algorithm can be a regular metric such as BM25 (see [2]) or TF-IDF (see [3]).
2. Semantic Search: semantic search seeks to improve search accuracy by understanding the user intentions and input context. This is done by calculating the distance between two words or sentences in an embedding space which can preserve semantic properties, such as a word2vec embedding. See [4]. In this case, the distance is a metric which indicates whether the elements being compared are similar to each other (closer distance) or different from each other (larger distance). One metric for this type of application is the cosine similarity function calculated over the meaning of the two elements in the function argument. In the case of one or more embodiments, the information value IV is defined based on the cosine similarity, which is a value between −1 and 1, where, the more similar two vectors are, the higher the IV is. The IV does not need to be necessarily equal to the cosine similarity, but could be scaled or normalized to whatever other range is relevant to a given application.

It is noted that there are other algorithms that could be used to assign a value for the IV of a document given a user query. Thus, the aforementioned methods are provided only by way of example and do not constitute an exhaustive list.

### B.4 Branch and Bound (BnB)

The BnB technique is utilized for solving integer programming problems, and its core principle is to solve an approximated, that is, easier, version of the original problem for later evaluating the unfeasible elements in the solution. Once these elements are found, the method branches out for new subproblems where the unfeasible portions of the solution are restricted into the feasible space. In other words, the BnB algorithm involves subdividing the original problem into sub-problems and, through the branching operation, searching for the set of solutions of these problems to identify the best solution. See [5]. It is noted that branch and bound is different from searching all the possible solutions with regular tree searching, since BnB prunes sub-optimal solutions paths which considerably shortens its running time, relative to an approach in which all possible solutions are searched.

To start the branch and bound tree, a root node is created with a linear relaxation of the original problem, that is, the condition where xᵢ∈{0,1}∀i is replaced with 0≤xᵢ≤1∀i, this includes all the real numbers between 0 and 1 as feasible spaces to search for a solution to the problem. This is done because it will allow items to be fractioned during the search for a solution, which makes the problem much easier to solve, as one can pick as much as desired from each of the items with highest relative value (vᵢ/wᵢ). Thus, the solution of the relaxed problem is not only easier to find but is also the maximum possible value that can be found for the original integer version of the problem. Even though understanding that a linear relaxed solution for this problem is an upper bound, the reference [5] provides a mathematical proof.

After solving the initial relaxation, if the solution of the problem presents one or more non-integers in its solution set, for example xₙ, BnB proceeds by creating a root node for one of these non-integer items and branches the root node into two subproblems, which are also nodes, where one subproblem assumes the item to be picked (xₙ=1) and the other subproblem assumes the item was let go (xₙ=0). In this way, a restriction on the solution space is applied.

Once this happens, each of the other branched nodes is solved by relaxing the problem again, and the process may continue if a valid and better solution can still be found by following this branch, or the branch can be pruned if the problem becomes unfeasible, or if a better solution cannot be found by following this branch. To summarize, BnB can be implemented with the following operations:
1. Initialization: initial problem relaxation, node 0;
2. Branching: choosing a non-integer dimension of the solution and branching to xₙ=0 and xₙ=1;
3. Bounding: pruning a node from the tree, this can happen for:
   Unfeasibility: if choosing 1 for this item will violate the weight capacity constraint;
   Integrality: if the solution in the node is feasible; or
   Limitation: if the best value for the relaxation of this node is equal to or worse than the best value for the subproblem relaxation of a previous node; and
4. Termination: the best solution is found

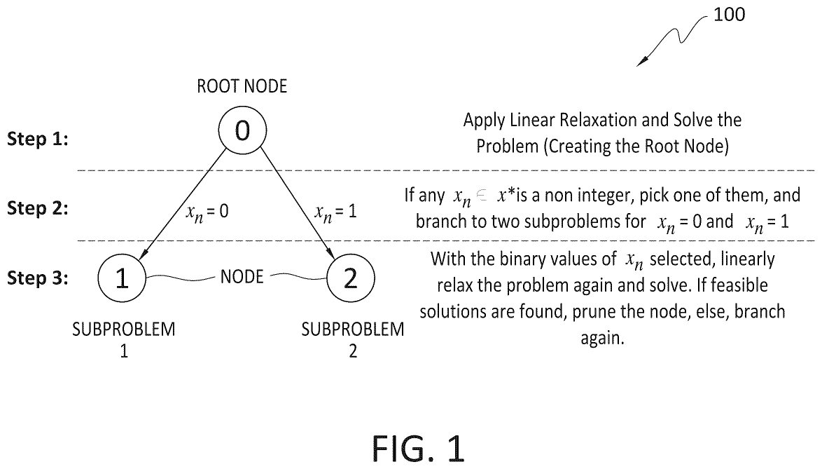

With reference now to FIG. 1, a generic example of a tree diagram of BnB method is shown at 100. In particular, FIG. 1 discloses a schema 100 of the BnB algorithm. The BnB method begins by solving the initial relaxed version of the problem, as represented by the ‘root node’ and proceeds by evaluating the relaxed solution while branching the non-integer values to nodes representing a Subproblem 1 and Subproblem 2, and replacing them with 0 and 1. The process repeats until all nodes are labeled as one of ‘unfeasible,’ ‘feasible’ or ‘limited.’ A quantitative and comprehensive example of BnB is discussed elsewhere herein as well.

### C. OVERVIEW OF ASPECTS OF ONE OR MORE EMBODIMENTS

As stated earlier herein, a fundamental problem with retrieval-based LLMs is selecting the best sources to retrieve while considering two parameters: (1) how well the document holds information that answers the user question, that is, what is the information value of the document; and (2) how large the retrieved document is. Choosing the optimal set of documents while: maximizing (1); and respecting the constraint in (2) presents itself as a combinatorial optimization problem known as the Knapsack Problem (KP).

With the foregoing in view, one or more embodiments comprise a framework to decide the information values of sources and to model the problem in a way that metaheuristics can be applied to find an optimal set of retrieved documents for a given query. In one embodiment, the steps of this framework are:
1. use a methodology such as lexical and semantic similarity search to attribute an Information Value (IV) to each source given a user input query;
2. attribute a tuple of IV and token size (s) for each document; and
3. apply a metaheuristic such as branch and bound (BnB) to search for the set of documents that maximize the summation of all IVs from the chosen documents while respecting the maximal input size (S) of the LLM.

As disclosed herein, one or more embodiments may comprise various useful features and aspects, although no embodiment is required to possess any of such features or aspects. The examples set forth hereafter are illustrative, but not exhaustive.

In more detail, one or more embodiments comprise a framework that enables documents to be optimally searched and, when combined with an LLM prompt, can provide the best and most up to date response to a user query. Thus, a method according to one embodiment may manage the trade off and choose the set of documents that, considered individually, may not necessarily have the highest IV values, but collectively have the highest sum of IV while respecting the allowed prompt length. In one embodiment, this method is an improvement to the naïve approach of RAG that simply chooses the highest IV document but disregards the document size, and an embodiment may also improve on RAG methods based on documents that all have the same fixed size.

One such feature of an embodiment is a method that optimally combines IVs and number of tokens into a tuple. Another feature of an embodiment is that an embodiment may comprise a reformulation of RAG preprocessing framework method that allows document retrieval to be performed via metaheuristics, to find an optimal document set. An embodiment may comprise an improvement over standard RAG approaches as such embodiment may be aware of, and account for, a trade-off between number of tokens and information value. An embodiment may quantitatively find an optimal solution that maximizes gathered information, and thus contrasts with RAG, which does not assure optimal information and simply fills the information context window selecting the documents in a top-down fashion with the top being the highest IV.

In contrast with one or more embodiments, RAG techniques, though well studied and established as a way to enable LLMs to perform better in situations where a user needs information that is not present in the model training dataset, do not use IVs such as lexical and semantic scores to pose the retrieval task as a combinatorial optimization problem that can be solved by a metaheuristic, as is done in one or more embodiments. In some circumstances, at least, use of these metaheuristics in an embodiment enables significantly more information to be included in the LLM context, compared to conventional RAG implementations.

### D. DETAILED DISCUSSION OF ASPECTS OF ONE OR MORE EMBODIMENTS

As noted earlier herein, an embodiment may pose RAG as an optimization problem, and may solve that problem by returning the best document set, that is, the set of documents that (1) maximizes information gain while (2) respecting the number of tokens reserved to the context section of the prompt.

### D.1 Problem Formulation: Enhancing RAG by Posing it as a KP

As explained earlier herein, LLMs can benefit greatly from external context to generate higher quality and up to date outputs, allowing these models to extend their domain of application to areas where they have not been trained on or where the information utilized in training is no longer valid. The caveat of this operation is that language models have a fixed amount, or budget, of input tokens and only a subset of these tokens can be used to allocate the external retrieved information necessary to enrich and update the LLM response with the current “state of the art” of the conversation context. The rest of the input tokens are shared among several instructions, such as personas, what the LLM is and is not supposed to respond to, and even the conversation log of the current conversation session.

Given the token limitation in the context window for RAG, it is possible to look at this problem in terms of combinatorial optimization, where the context window for retrieved content is the problem restriction, that is, knapsack capacity, and each possible document to be retrieved with RAG is an item with a value and weight, respectively attributed by algorithms such as those disclosed herein, and the number of tokens in the document.

Thus, an adapted formulation of the Knapsack Problem for RAG can be given by:

$$maximize {\sum }_{i = 1}^{N} I {V}_{i} {p}_{i}$$

$$subject to {\sum }_{i = 1}^{N} {s}_{i} {p}_{i} \leq S and {p}_{i} ∈ \{ 0 , 1 \}$$

where the information value of each document is IVᵢ, the index that indicates if the document is picked is pᵢ, the size/number of tokens of each document is sᵢ and the maximum total number of tokens for retrieved documents is S. With this formulation, the resultant retrieved documents are optimally selected by an embodiment, providing a context potentially richer in information and with reduced token space when compared with the naïve approach used by RAG.

### D.2 Aspects of an Example Framework According to One Embodiment

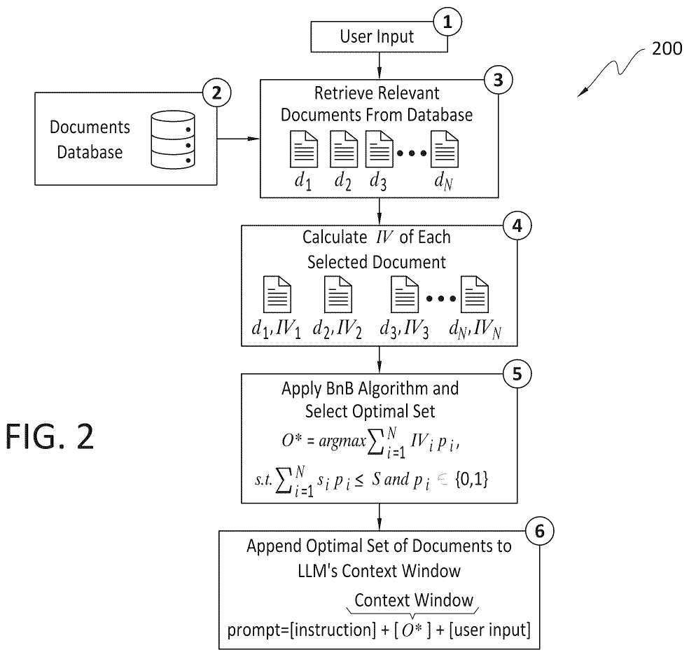

With attention now to the example of FIG. 2, an example method 200 according to one embodiment is disclosed. As discussed hereafter, the example method 200 may operate to identify an optimal set of documents after document retrieval.

In more detail, the method 200, which may be performed in whole or in part by an LLM, for obtaining an optimal document set (O*) for an enhanced RAG framework may begin with the receipt of user input (1). In LLM applications, this user input may comprise a user query sent to an entity, such as a LLM-based chatbot, through an interface. As further indicated in FIG. 2, a database (2) may be provided that is accessible by the LLM. The database (2) may include documents and/or other information including, but not limited to, files, charts, metadata, graphs, text files, audio files, photographs, and video files. Information in the database (2) may be used by the LLM to provide relevant external context related to the user input (1), that is, a user query.

After receiving the user input (1), the method 200 may proceed to (3) where documents, and/or other information, relevant to the user input are retrieved from the database (2). After the documents and/or other information have been retrieved (3), the information value IV may be calculated (4) for each document, and a count performed of the token length s for each document.

Next, an optimal document set O* may be selected (5) by application of the BnB algorithm for the complete set of documents. That is, O* is the set of documents which maximize the amount of information to be conveyed to the user, while also respecting the context window size, or total permissible number of tokens.

Last, an optimal prompt is formed (6). Here, the optimal set of documents O* is inserted in the context window for enhancing the LLM output with the gathered external documents. This information may then be returned to the use as a response to the initial user input (1).

### E. ILLUSTRATIVE EXAMPLE OF APPLICATION OF AN EMBODIMENT

Following is a discussion of an application of one example embodiment that employs simulated numerical values for IVs, token lengths and context window size. This example is presented for illustration purposes, and is not intended to limit this disclosure, or any claims, in any way.

### E.1 Selecting and Evaluating Documents

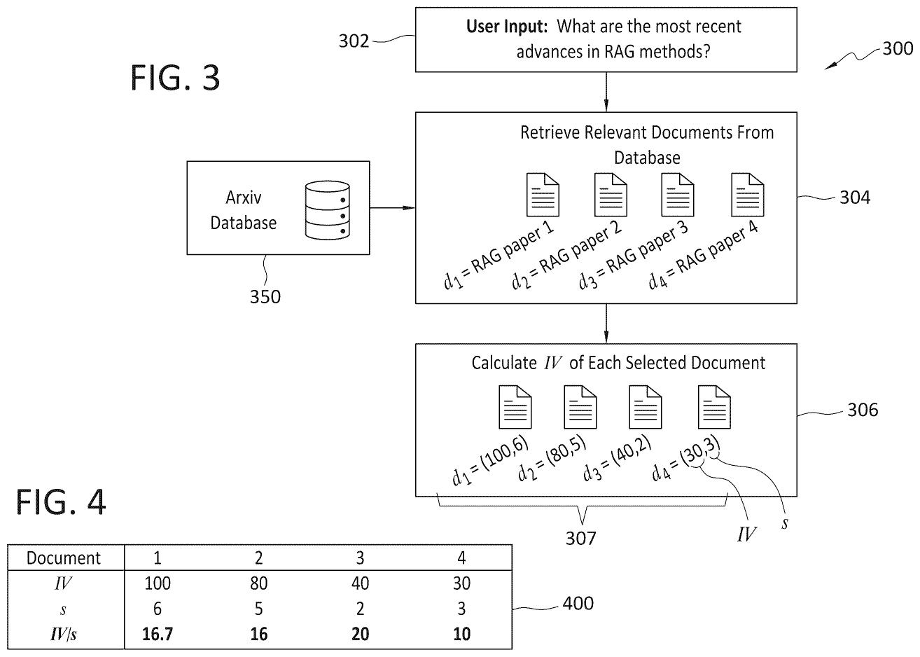

With reference now to the example method 300 of FIG. 3, whenever a message 302, such as a query or request, is issued by the user, the standard RAG framework returns from the database a set of N documents, 4 in this illustrative example, that are considered fitting, that is responsive to the user query, for external context enhancing. Thus, in the illustrated example, if the user wants to know more about RAG methods and the LLM has access to an ArXiv database 350, the chatbot response can be enhanced by retrieving 304 external content provided by state-of-the-art research and located in the ArXiv database 350. The retrieved documents may then be evaluated 306 and an information value IV calculated for each document using an algorithm for document ranking, such those algorithms disclosed elsewhere herein. Then, a tuple 307 consisting of the IV and token size s is built for each document that was retrieved 304. In the example of FIG. 3, there are four tuples dᵢ, namely, d₁, d₂, d₃, and d₄.

### E.2 Solving the BnB Problem

With the tuples (IV, s) created for each document, an embodiment may then, finally, apply the branch and bound algorithm to find the optimal set of documents available to the context window. Here, this illustrative example considers a didactic value for context window of S=10, thus, the problem formulation becomes:

$$maximize : 100 {p}_{1} + 80 {p}_{2} + 40 {p}_{3} + 30 {p}_{4}$$

$$subject to : 6 {p}_{1} + 5 {p}_{2} + 2 {p}_{3} + 3 {p}_{4} \leq 10 where {p}_{i} ∈ \{ 0 , 1 \} ∀ i$$

To form the root node of the BnB search tree, the discrete formulation is relaxed to its continual form and solved. The problem relaxation is the following:

$$maximize : 100 {p}_{1} + 80 {p}_{2} + 40 {p}_{3} + 30 {p}_{4}$$

$$subject to : 6 {p}_{1} + 5 {p}_{2} + 2 {p}_{3} + 3 {p}_{4} \leq 10 where 0 \leq {p}_{i} \leq 1 ∀ i$$

The table 400 in FIG. 4 shows the relative value of each document used to find the best possible solution for the relaxed problem. In particular, Table 400 includes didactic values which represent the information value (IV), token size (s) and relative value IV/s of each document. Table 400 also discloses the tuple for each document—for example, the tuple for document 1 is (100,6), as also shown in FIG. 3.

Calculating the relative information value IV/s it can be seen that the most valuable documents per token are respectively: d₃, d₁, d₂ and d₄. Considering that d₃ has the highest value of relative information (100) and may be selected entirely without violating the restriction s=10 (since s=6 for d₃), an embodiment may select p₃=1. The second document with the highest relative value is d₁ and an embodiment may also pick d₁ together with d₃, given that the sum of their entire number of tokens is 8, which respects the context window restriction of s=10, while leaving a remainder of 2, thus, p₁=1.

Moving next to d₂ that has s=5, picking d₂ on its entirety will violate the restriction s=10. Thus, only the fraction of d₂ that will satisfy the upper bound S is selected, where this fraction is p₂=⅖, and as the context window is full, d₄ will not be selected at all and, as such, p₄=0. The optimal solution for the relaxed problem then becomes:

$${p}^{*} = ( 1 , 2 / 5 , 1 , 0 )$$

This solution has a total value of v*=172 which is the upper bound of what can be expected to be found when solving the problem in its integer form. However, as there is a fraction of ⅖ in the vector of solutions, an embodiment may have to create two subproblems that span from the root solution, and then explore scenarios where p₂=1 and p₂=0.

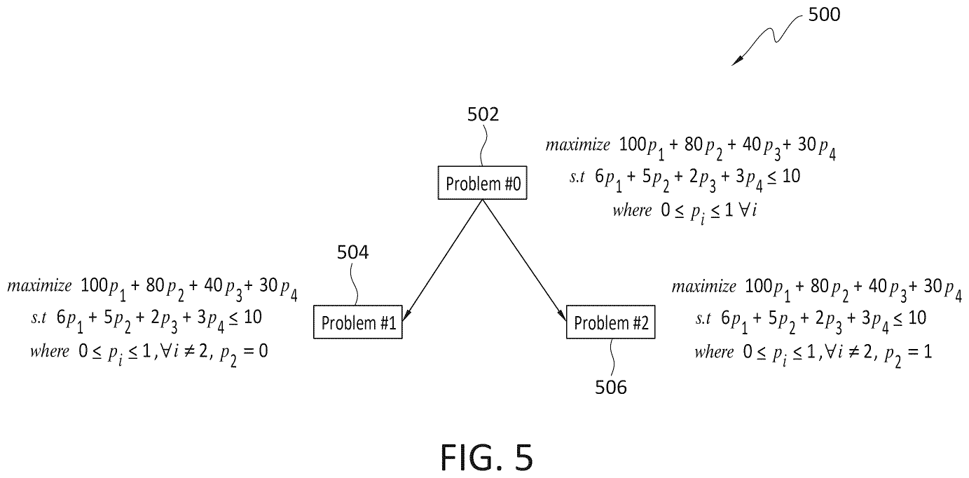

Turning next to the example of FIG. 5, an example BnB schema 500 shows the branching of the root solution (Problem #0) 502, to the other two starting subproblems, namely, (Problem #1) 506 and 508 (Problem #2). More particularly, FIG. 5 discloses a numerical example of initial branching with a BnB algorithm, the initial problem is relaxed and solved, creating the root node (Problem #0), the branching operation creates Problem #1 and Problem #2, where p₂=0 and p₂=1 respectively.

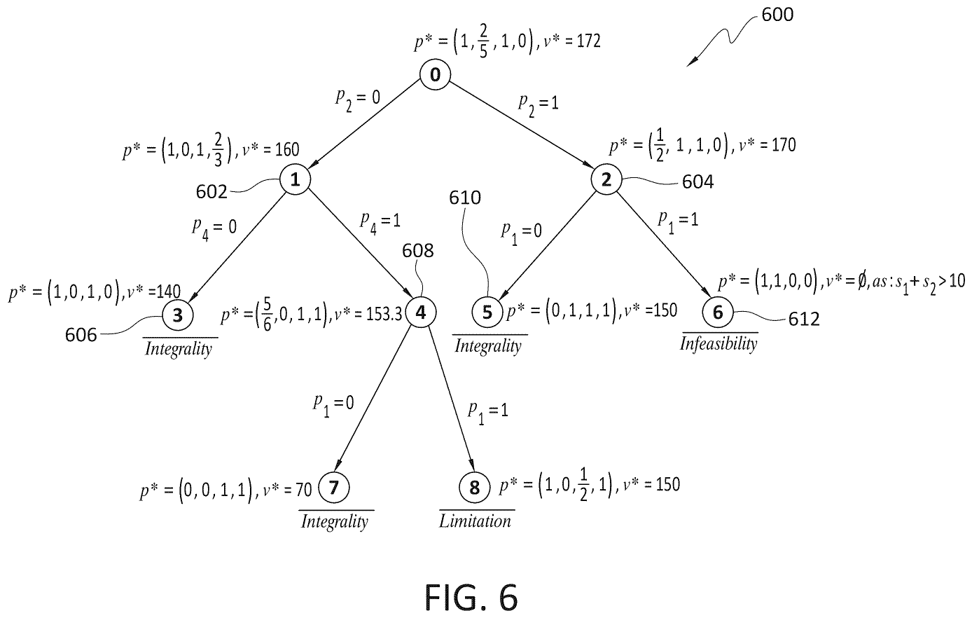

An embodiment may solve Problem #1 and Problem #2 with the same relaxation rules as applied to Problem #0 at the root node, with the exception that p₂ is this time discrete, that is, either 1 or 0. As shown in the example BnB schema 600 in FIG. 6, the solution of these problems yields: {p*=(1,0,1, ⅔), v*=160} for the first problem at node #1 602 (p₂=0) and {p*=(½, 1,1,0), v*=170} for the second problem and node #2 604 (p₂=1).

Again, however, two fractions are still present in both of the solutions, which forces the creation of 4 additional subproblems 606, 608, 610, and 612 for, respectively, node #3, node #4, node #5, and node #6, that is, two subproblems for each of node #1 and node #2. For brevity, FIG. 6 discloses a summarized form of the new subproblems and their solutions, as well as how an embodiment may avoid expanding the search tree indefinitely. The rationale behind each node 1 through 8 in FIG. 6 is as follows:
Node 0: This node presents the solution of the initial problem with a linear relaxation;
Node 1: This node is the first branch, where the variable p₂ is set to 0 and the problem is linearly relaxed again to find the p*=(1, 0,1, ⅔), this solution still doesn't satisfy the problem's restrictions as p₂ is not an integer between 0 and 1, thus we branch to nodes 3 and 4;
Node 2: The second problem is also a branch of Problem 0 and assumes p₂=1, the solution is, p*=(½, 1,1,0) and the problem needs to branch for problems 5 and 6 due to the value of p₁=½;
Node 3: Problem 3 is solved by following the branches and fixing p₂=0 and p₄=0, the solution is p*=(1, 0,1,0), this solution satisfies all problem's constraints, thus this node is pruned for Integrality;
Node 4: This node sets p₂=0 and p₄=1, this problem's relaxed solution is

$${p}^{*} = ( \frac{5}{6} , 0 , 1 , 1 ) ,$$

which requires the creation of problems 7 and 8;
Node 5: Problem 5 is solved restricting p₂=1 and p₁=0, its solution is p*=(0, 1,1,1) and satisfies all constraints, thus, this node is pruned by Integrality;
Node 6: Requires p₂=1 and p₁=1, by this requirement we observe that the total number of tokens is 11, which exceeds our restriction of 10 maximum, this node is then pruned by Infeasibility;
Node 7: This node has p₂=0, p₄=1 and p₁=0, it has a feasible solution of p*=(0, 0,1,1) and is pruned by Integrality;
Node 8: This problem is restricted by p₂=0, p₄=1 and p₁=1, the solution at this node yields p*=(1, 0,1/2,1), which would require further branching, however, the value of this solution is v*=150. By looking at the BnB tree we observe that at Node 5 we have a feasible solution with value of v*=150.

Proceeding down the tree of the BnB schema 600, the upper bound of the next layer is always given by the highest value of the previous layer, due to the ever-increasing restrictions added to the pᵢ values. Thus, for example, no solution after Node 0 will ever be better than the Node 0 solution, given that this is the problem solved on its most relaxed form—recalling however that this solution is not feasible, which is the reason for branching, as shown in FIGS. 5 and 6—and based on this logic, Node 8 is pruned by Limitation as it is unfeasible and no solution derived from Node 8 can ever be better than the solution of Node 5.

Following the rationale explained at each node, the optimal list of documents to be added to the context is O*=[d₂, d₃, d₄], which is nonintuitive as the conventional, or naïve, RAG approach would start by selecting the most valuable document d₁, thus never reaching the set which maximizes the total information value, that is, the optimal document set. Thus, as disclosed in FIG. 6, the tree is explored, and nodes are pruned due to necessity, and the optimal solution is found in node 5.

### F. FURTHER EXAMPLE EMBODIMENTS

Following are some further example embodiments. These are presented only by way of example and are not intended to limit the scope of this disclosure or the claims in any way.

Embodiment 1. A method for optimizing information retrieval, comprising: receiving, from a user, a query; in response to the query, retrieving information that comprises documents relevant to the query; calculating a respective information value (IV) for each of the retrieved documents; counting a token length for each of the retrieved documents; selecting, from among the retrieved documents, an optimal document set that includes a set of the retrieved documents that maximizes an amount of information, while respecting a token budget; and inserting the optimal document set into a context window so as to enhance an output of an LLM with documents of the optimal document set.

Embodiment 2. The method as recited in any preceding embodiment, wherein the query is received from the user as part of a session between the user and a virtual entity.

Embodiment 3. The method as recited in any preceding embodiment, wherein a lexical and/or semantic similarity search is used to determine the information values for the retrieved documents.

Embodiment 4. The method as recited in any preceding embodiment, wherein a metaheuristic is used to search for those documents, among the retrieved documents, that maximize the amount of information.

Embodiment 5. The method as recited in embodiment 4, wherein the metaheuristic comprises BnB (branch and bound).

Embodiment 6. The method as recited in any preceding embodiment, wherein the optimal document set is returned to the user.

Embodiment 7. The method as recited in any preceding embodiment, wherein the optimal document set is identified using respective tuples (IV, s) for each of the retrieved documents, where IV is the information value of the document, and s is the token length of the document.

Embodiment 8. The method as recited in any preceding embodiment, wherein the LLM performs the retrieving, calculating, counting, and selecting, as part of a RAG (retrieval augmented generation) process.

Embodiment 9. The method as recited in any preceding embodiment, wherein selecting the optimal document set is a combinatorial optimization problem.

Embodiment 10. The method as recited in any preceding embodiment, wherein the output of the LLM comprises a prompt [instruction]+[optimal document set]+[query].

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

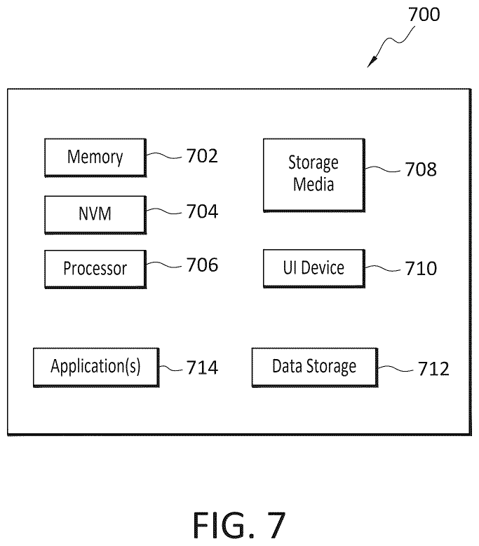

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for optimizing information retrieval, comprising:
receiving, from a user, a query;
in response to the query, retrieving information that comprises documents relevant to the query;
calculating a respective information value (IV) for each of the retrieved documents;
counting a token length for each of the retrieved documents;
selecting, from among the retrieved documents, an optimal document set that includes a set of the retrieved documents that maximizes an amount of information, while respecting a token budget; and
inserting the optimal document set into a context window so as to enhance an output of an LLM with documents of the optimal document set.

2. The method as recited in claim 1, wherein the query is received from the user as part of a session between the user and a virtual entity.

3. The method as recited in claim 1, wherein a lexical and/or semantic similarity search is used to determine the information values for the retrieved documents.

4. The method as recited in claim 1, wherein a metaheuristic is used to search for those documents, among the retrieved documents, that maximize the amount of information.

5. The method as recited in claim 4, wherein the metaheuristic comprises BnB (branch and bound).

6. The method as recited in claim 1, wherein the optimal document set is returned to the user.

7. The method as recited in claim 1, wherein the optimal document set is identified using respective tuples (IV, s) for each of the retrieved documents, where IV is the information value of the document, and s is the token length of the document.

8. The method as recited in claim 1, wherein the LLM performs the retrieving, calculating, counting, and selecting, as part of a RAG (retrieval augmented generation) process.

9. The method as recited in claim 1, wherein selecting the optimal document set is a combinatorial optimization problem.

10. The method as recited in claim 1, wherein the output of the LLM comprises a prompt [instruction]+[optimal document set]+[query].

11. A non-transitory storage medium having stored therein instructions that are executable by one or more hardware processors to perform operations comprising:
receiving, from a user, a query;
in response to the query, retrieving information that comprises documents relevant to the query;
calculating a respective information value (IV) for each of the retrieved documents;
counting a token length for each of the retrieved documents;
selecting, from among the retrieved documents, an optimal document set that includes a set of the retrieved documents that maximizes an amount of information, while respecting a token budget; and
inserting the optimal document set into a context window so as to enhance an output of an LLM with documents of the optimal document set.

12. The non-transitory storage medium as recited in claim 11, wherein the query is received from the user as part of a session between the user and a virtual entity.

13. The non-transitory storage medium as recited in claim 11, wherein a lexical and/or semantic similarity search is used to determine the information values for the retrieved documents.

14. The non-transitory storage medium as recited in claim 11, wherein a metaheuristic is used to search for those documents, among the retrieved documents, that maximize the amount of information.

15. The non-transitory storage medium as recited in claim 14, wherein the metaheuristic comprises BnB (branch and bound).

16. The non-transitory storage medium as recited in claim 11, wherein the optimal document set is returned to the user.

17. The non-transitory storage medium as recited in claim 11, wherein the optimal document set is identified using respective tuples (IV, s) for each of the retrieved documents, where IV is the information value of the document, and s is the token length of the document.

18. The non-transitory storage medium as recited in claim 11, wherein the LLM performs the retrieving, calculating, counting, and selecting, as part of a RAG (retrieval augmented generation) process.

19. The non-transitory storage medium as recited in claim 11, wherein selecting the optimal document set is a combinatorial optimization problem.

20. The non-transitory storage medium as recited in claim 11, wherein the output of the LLM comprises a prompt [instruction]+[optimal document set]+[query].
